(19) United States
(12) Patent Application Publication
(10) Pub. No.: US 2015/0110076 A1
(43) Pub. Date: Apr. 23, 2015

(54) REDUCING LATENCY DURING REDIRECTION

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/246,877

(22) Filed: Apr. 7, 2014

Related U.S. Application Data
(60) Provisional application No. 61/894,317, filed on Oct. 22, 2013.

(51) Int. Cl. H04W 36/00; H04W 52/40

(52) U.S. Cl. CPC H04W 36/0022; H04W 52/40
USPC 370/332; 370/331

(57) ABSTRACT

In a method of wireless communication, a UE is redirected to a first RAT due to circuit switch fallback via a connection release from the second RAT. The UE is redirected based on redirection information that includes a dedicated preamble and a time period for the UE to perform a random access procedure in the first RAT. In one instance, the UE performs the random access procedure with the dedicated preamble during the time period. In addition, the UE performs the random access procedure with a non-dedicated preamble when no response is received to the dedicated preamble when the time period expires.

### CROSS REFERENCE TO RELATED APPLICATION

The present application claims the benefit of U.S. provisional patent application No. 61/894,317, entitled “REDUCING LATENCY DURING REDIRECTION,” filed on Oct. 22, 2013, the disclosure of which is expressly incorporated by reference herein in its entirety.

### TECHNICAL FIELD

Aspects of the present disclosure relate generally to wireless communication systems, and more particularly, to reducing latency during redirection from one radio access technology (RAT) to another RAT.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method for wireless communication during circuit switch fall back (CSFB) is disclosed. The method includes receiving redirection information that includes a dedicated preamble(s) and time period(s). The method also includes performing a random access procedure with the dedicated preamble(s) during the time period. The method also includes performing the random access procedure with a non-dedicated preamble when no response is received to the dedicated preamble(s) when the time period expires.

Another aspect discloses an apparatus for CSFB and includes means for receiving redirection information that includes a dedicated preamble(s) and a time period. The apparatus also includes means for performing a random access procedure with the dedicated preamble(s) during the time period. The apparatus also includes means for performing the random access procedure with a non-dedicated preamble when no response is received to the dedicated preamble(s) when the time period expires.

Another aspect discloses a computer program product for wireless communications during CSFB in a wireless network having a non-transitory computer-readable medium. The computer readable medium has non-transitory program code recorded thereon which, when executed by the processor(s), causes the processor(s) to perform operations of receiving redirection information including a dedicated preamble(s) and a time period. The program code also causes the processor(s) to perform a random access procedure with the dedicated preamble(s) during the time period. The program code also causes the processor(s) to perform the random access procedure with a non-dedicated preamble when no response is received to the dedicated preamble(s) when the time period expires.

Another aspect discloses an apparatus for wireless communication during CSFB and includes a memory and at least one processor coupled to the memory. The processor(s) is configured to receive redirection information having a dedicated preamble(s) and a time period. The processor(s) is also configured to perform a random access procedure with the dedicated preamble(s) during the time period. The processor(s) is also configured to perform the random access procedure with a non-dedicated preamble when no response is received to the dedicated preamble(s) when the time period expires.

In another aspect, a method of wireless communication during circuit switch fall back (CSFB) is disclosed and includes transmitting redirection information having a dedicated preamble(s) and time period. The method also includes transmitting an indicator to inform a user equipment (UE) when the dedicated preamble(s) is already transmitted or identified to be transmitted to other UEs.

Another aspect discloses an apparatus for wireless communication during CSFB and includes means for transmitting redirection information having a dedicated preamble(s) and time period. The apparatus also includes means for transmitting an indicator to inform a user equipment (UE) when the dedicated preamble(s) is already transmitted or identified to be transmitted to other UEs.

Another aspect discloses a computer program product for wireless communications in a wireless network during CSFB and includes a non-transitory computer-readable medium. The computer readable medium has non-transitory program code recorded thereon which, when executed by the processor(s), causes the processor(s) to perform operations of transmitting redirection information including a dedicated preamble(s) and a time period. The program code also causes the processor(s) to transmit an indicator to inform a user equipment (UE) when the dedicated preamble(s) is already transmitted or identified to be transmitted to other UEs.

Another aspect discloses an apparatus for wireless communication having a memory and at least one processor coupled to the memory. The processor(s) is configured to transmit redirection information including a dedicated preamble(s) and a time period. The processor(s) is also configured to transmit an indicator to inform a user equipment (UE) when the dedicated preamble(s) is already transmitted or identified to be transmitted to other UEs.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 illustrates a call flow of a typical network.

FIG. 6 illustrates a call flow of another typical network.

FIG. 7 illustrates a timing diagram of a typical random access process.

FIG. 8 is a block diagram illustrating a wireless communication method for a dedicated preamble according to aspects of the present disclosure.

FIG. 9 is a block diagram illustrating a wireless communication method for another dedicated preamble according to aspects of the present disclosure.

FIG. 10 is a block diagram illustrating an example of a hardware implementation for an apparatus employing a processing system.

FIG. 11 is a block diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

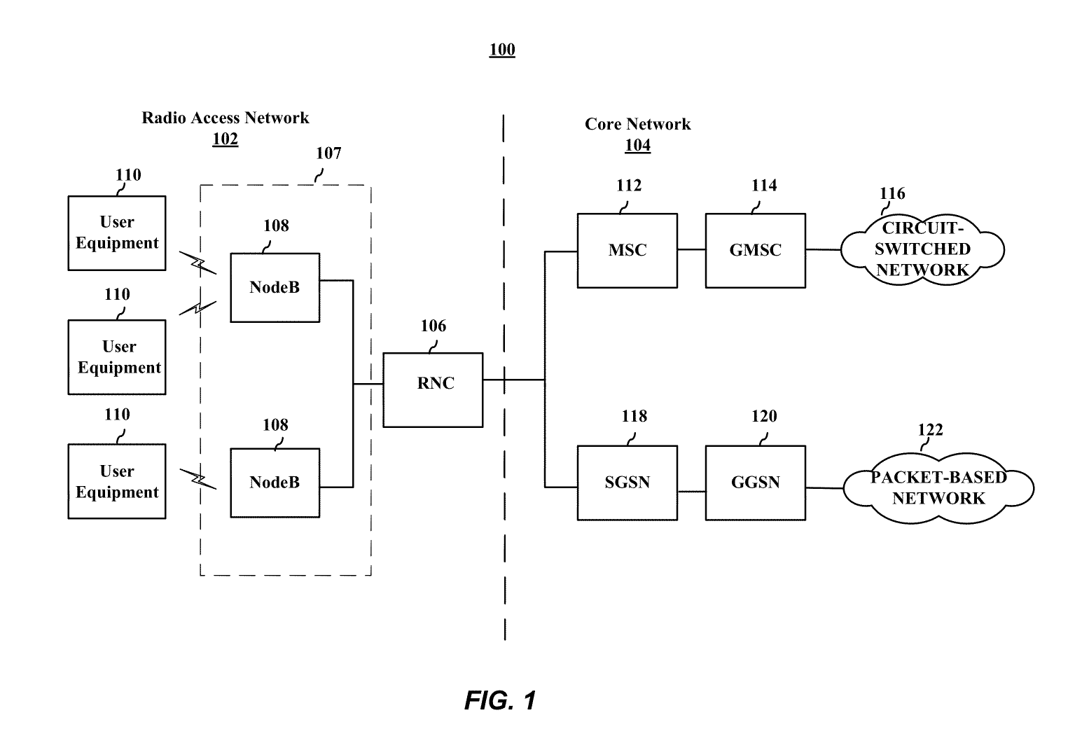

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the period that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

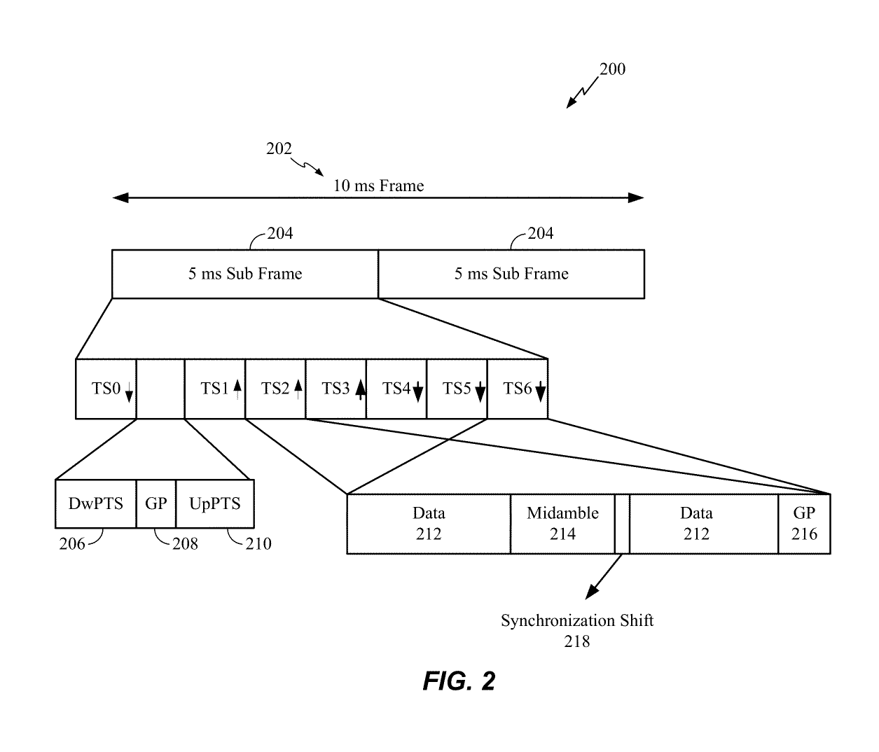

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. SS bits 218 only appear in the second part of the data portion. The SS bits 218 immediately following the midamble can indicate three cases: decrease shift, increase shift, or do nothing in the upload transmit timing. The positions of the SS bits 218 are not generally used during uplink communications.

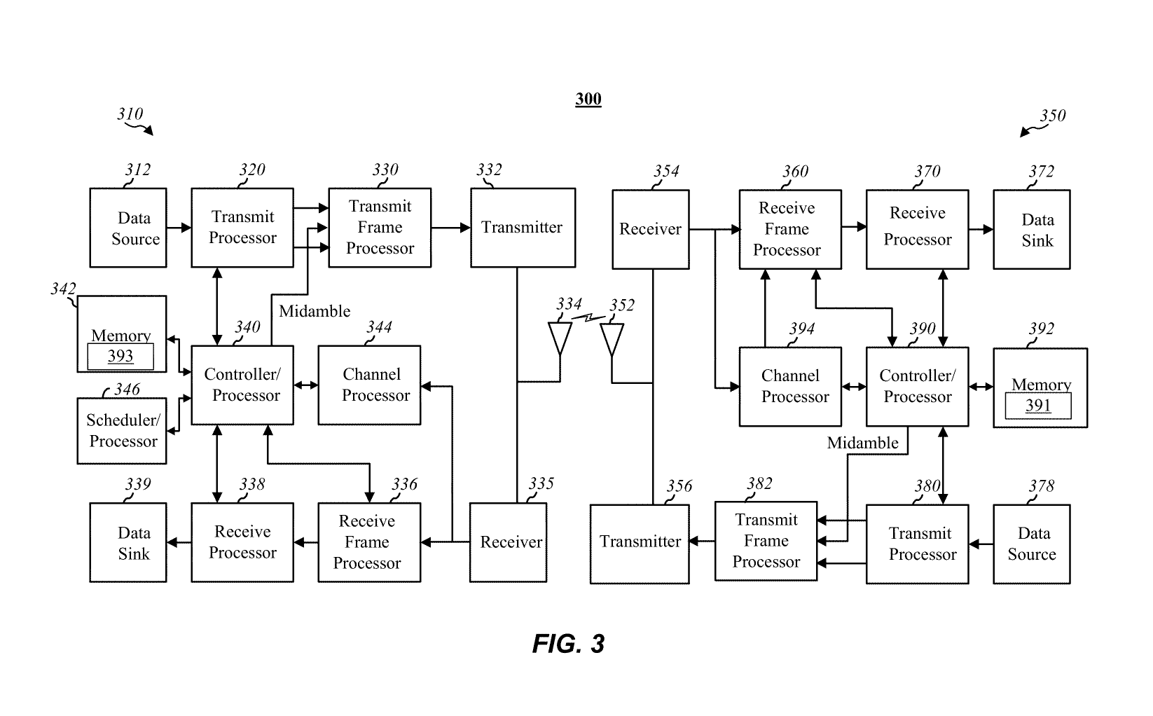

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a circuit switched fall back (CSFB) module 391 which, when executed by the controller/processor 390, configures the UE 350 to perform random access procedure with preambles based on aspects of the present disclosure. Similarly, the memory 342 of the node B 310 may store a CSFB module 393 which, when executed by the controller/processor 340, configures the node B 310 to perform random access procedure based on aspects of the present disclosure. A scheduler/processor 346 at the node B 310 may be used to allocate resources to the UEs and schedule downlink and/or uplink transmissions for the UEs.

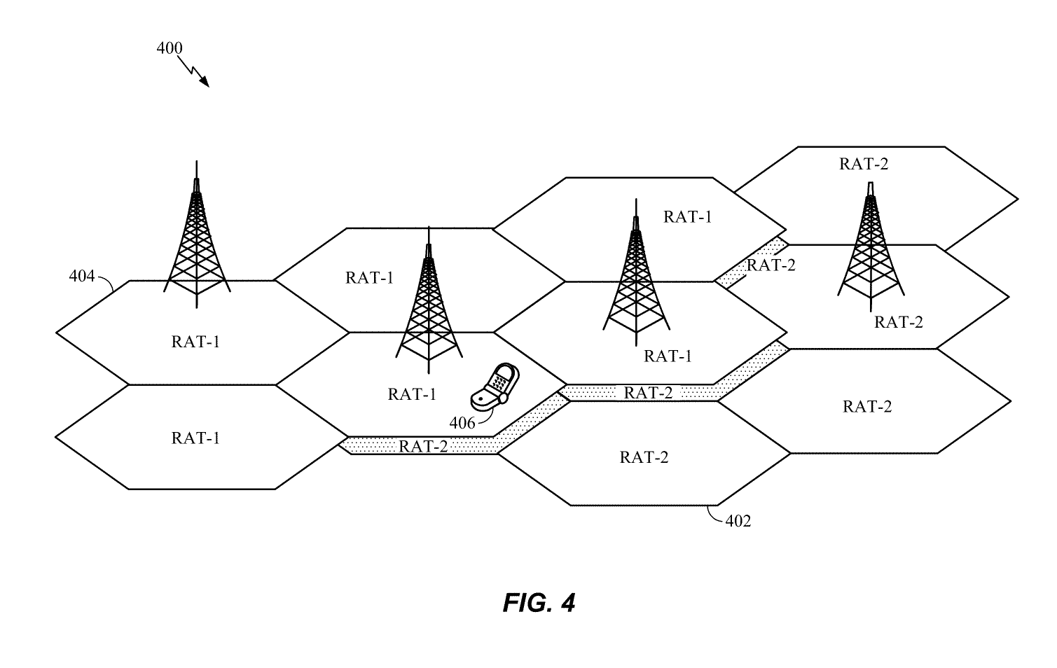

FIG. 4 illustrates coverage of a newly deployed network utilizing a first type of radio access technology (i.e., RAT-1), such as a Long Term Evolution (LTE) or TD-SCDMA network, and also coverage of an established network utilizing a second type of radio access technology (i.e., RAT-2), such as a GSM network. In this deployment of a network, a user equipment (UE) may be in the vicinity of the first RAT but continue to perform inter-radio access technology (inter-RAT) measurement of the second RAT. This measurement may be implemented for a cell or base station reselection procedure from the first RAT to the second RAT.

The geographical area 400 includes RAT-1 cells 404 and RAT-2 cells 402. In one example, the RAT-1 cells are LTE cells and the RAT-2 cells are TD-SCDMA or GSM cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

Handover or cell reselection from a first radio access technology (RAT) to a second RAT may occur for several reasons. First, the network may prefer to have the user equipment (UE) use the first RAT as a primary RAT but use the second RAT simply for voice service(s). Second, there may be coverage holes in the network of one RAT, such as the first RAT.

The handover or cell reselection may be performed when the UE moves from a coverage area of a TD-SCDMA cell to the coverage area of a GSM cell, or vice versa. A handover or cell reselection may also be performed when there is a coverage hole or lack of coverage in the TD-SCDMA network or when there is traffic balancing between the TD-SCDMA and GSM networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a GSM neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Other radio access technologies, such as a wireless local area network (WLAN) or WiFi may also be accessed by a user equipment (UE) in addition to cellular networks such as TD-SCDMA or GSM. For the UE to determine nearby WiFi access points (APs), the UE scans available WiFi channels to identify/detect if any WiFi networks exist in the vicinity of the UE. In one configuration, the UE may use TD-SCDMA reception/transmission gaps to switch to the WiFi network to scan the WiFi channels.

### Reduce Latency of Circuit Switch Fallback

Aspects of the disclosure are directed to reducing latency of circuit-switched fallback (CSFB) from one radio access technology (RAT) to another RAT, such as LTE to Time Division-Code Division Multiple Access (TD-CDMA). When a user equipment (UE) is redirected from a first RAT to a second RAT, redirection information received by the UE includes one or more dedicated preambles and a time period for the UE to use the dedicated preambles to perform a random access procedure. The UE performs the random access procedure with one of the dedicated preambles during the time period. However, when a random access response to the dedicated preamble is not received by the UE, the UE performs the random access procedure with a non-dedicated preamble after the time period expires.

Redirection from one RAT to another RAT is commonly used to perform operations such as load balancing, or circuit-switched fallback from one RAT to another RAT. For example, one of the RATs may be Long Term Evolution (LTE) while the other RAT may be Universal Mobile Telecommunications System-Frequency Division Duplexing (UMTS FDD), Universal Mobile Telecommunications System-Time Division Duplexing (UMTS TDD), or Global System for Mobile Communications (GSM).

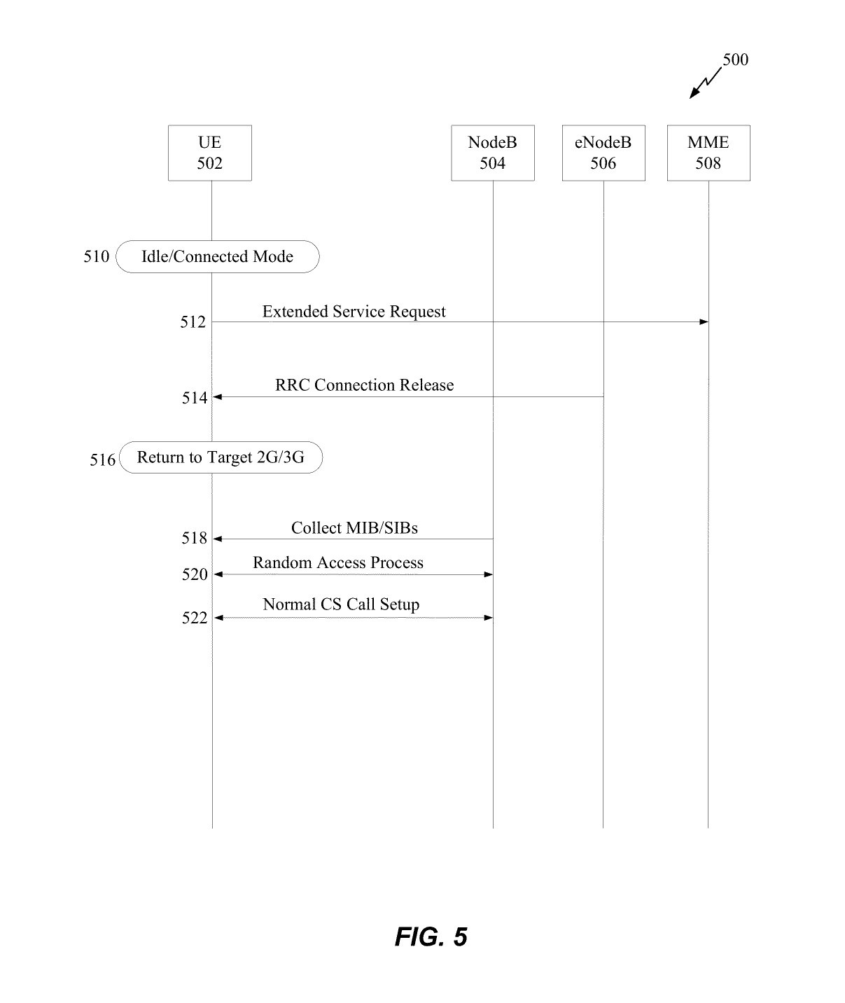

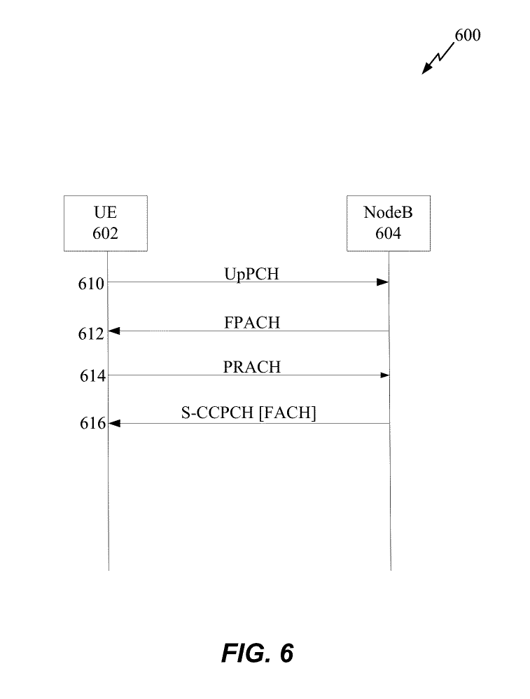

Circuit-switched fallback (CSFB) is a feature that enables multimode user equipment (UE) to provide available circuit-switched (CS) voice services. Multimode UEs refer to UEs that are capable of communicating on a first RAT while connected to a second RAT. In one configuration, the first RAT is a third/second generation (3G) mobile phone technology (3G/2G), such as TD-SCDMA, and the second RAT is LTE or vice versa. For example, a circuit-switched fallback capable UE may initiate a mobile-originated (MO) circuit-switched voice-call while on LTE. The initiated voice call may result in the UE being moved to a circuit-switched capable radio access network (RAN), such as 3G or 2G for a circuit-switched voice-call setup. A circuit-switched fallback capable UE may also be paged for a mobile-terminated (MT) voice call while on a specific RAT. The page may result in the UE being moved to another RAT for circuit switched voice call setup. Exemplary CSFB operations are illustrated by FIGS. 5 and 6.

FIG. 5 is a call flow diagram 500 illustrating a typical network operation. A UE 502 is engaged in communications with a TD-SCDMA NodeB 504, an LTE eNodeB (or base station) 506 and a mobility management entity (MME) 508, which may be a key control node for the network. At time 510, the UE 502 is in the idle or connected mode with the LTE network. At time 512, the UE 502 transmits an extended service request to the MME 508. The extended service request may be an indicator for a mobile-originated (MO) or mobile-terminated (MT) circuit-switched fallback (CSFB) call. For example, the extended service request may indicate a circuit-switched fallback call is being made.

At time 514, the eNodeB 506 transmits a radio resource control (RRC) connection release message to the UE 502. The RRC connection release message may be without any 2G or 3G redirection information. A fast return flag may also be transmitted with a true value at time 514. Other information, such as, but not limited to, target cell quality may be transmitted at time 514. At time 516, the UE 502 moves to the 2G/3G network. At time 518, the UE 502 receives from the TD-SCDMA NodeB 504a the master information block (MIB) and the system information blocks (SIBs). At time 520, the UE 502 and the TD-SCDMA NodeB 504 are in communications with each other to perform a random access process. At time 522, the UE 502 and the TD-SCDMA NodeB 504 perform a circuit-switched (CS) call setup.

FIG. 6 is a call flow diagram 600 illustrating a random access procedure. A UE 602 may be in communications with a NodeB (or base station) 604. At time 610, the UE 602 selects and transmits one of N synchronization uplink (SYNC-UL) sequences to the NodeB 604. In one example configuration, N may be eight (8). The transmission at time 610 may occur over an uplink pilot channel (UpPCH). For example, the UE randomly selects one UpPCH sub-channel and one synchronous uplink (SYNC-UL) sequence (e.g., preamble) from those available for an access service class (ASC). The UE may transmit the synchronous uplink sequences on the UpPCH sub-channel. The synchronous uplink sequences may be transmitted at the UE's signature transmission power. After transmitting a synchronous uplink sequence, the UE listens for a relevant fast physical access channel (FPACH) during a predefined time (the next wait time (WT) subframes) to receive the network acknowledgement.

At time 612, the UE 602 receives an acknowledgment signature as well as power and timing adjustment commands from the NodeB 604. In one configuration, the transmission at time 612 may take place on the FPACH. At time 614, the UE 602 uses codes associated with the FPACH in addition to the power and timing adjustment commands, to transmit a signal to the NodeB 604. In one configuration, the transmission at time 614 may take place over a physical random access channel (PRACH). At time 616, the NodeB 604 assigns channels with information that includes carriers, codes, time slots and midambles. The NodeB 604 then transmits this information including carriers, codes, time slots and midambles to the UE 602. A secondary common control physical channel (S-CCPCH) or a forward access channel (FACH) may be used for the transmission at time 616. The secondary common control physical channel may function as a forward access channel.

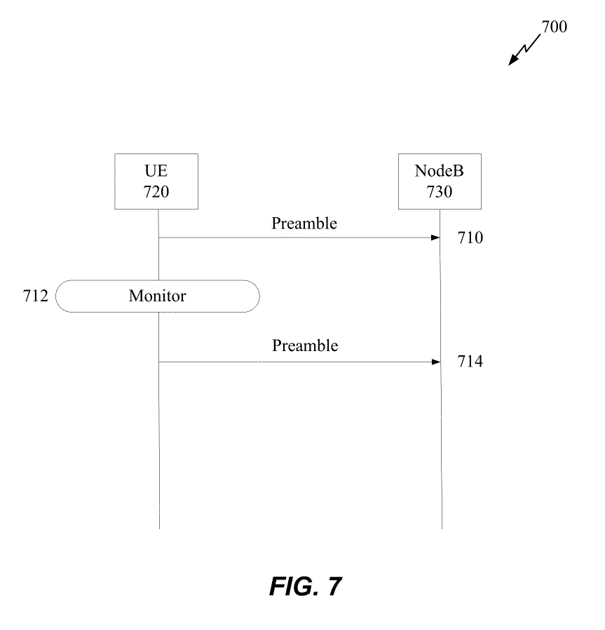

As noted, when a UE of interest moves between RATs due to circuit-switched fallback after collecting system information blocks from the second RAT (e.g., LTE), the UE of interest and the first RAT (e.g., TD-SCDMA) are in communication to perform the random access process. An exemplary random access process is illustrated by FIG. 7.

FIG. 7 illustrates a timing diagram 700 of a conventional random access process. The UE 720 transmits a first preamble (or synchronous uplink signal) at a first time instance 710 to a NodeB 730. As noted, the UE may randomly select the preamble from the N synchronous uplink sequence(s). The UE 720 then waits for a wait time period 712 to elapse. During the wait time period 712, the UE 720 monitors for a response to the transmitted first preamble. For example, the UE may listen to the relevant FPACH for the next wait time subframes to receive a network acknowledgment. The UE 720 may initiate a voice call if there is a response from the NodeB 730. Alternatively, if there is no response, after the wait time period 712 elapses, the UE 720 retransmits the preamble at a second time instance 714. The UE 720 may transmit the preamble with a higher power level during the retransmission.

When a preamble collision occurs, or when the UE is in a bad propagation environment, the NodeB may not receive the preamble or detect the random access request for the UE of interest. As a result, the UE may not receive any response from the NodeB. In some instances, a collision may occur when other UEs select the same preamble as the UE of interest to initiate a random access request during the random access process. For example, when the collision occurs, the NodeB may not receive preambles for multiple UEs. As a result, the UEs do not receive a response from the NodeB. After the wait time period expires, the UE of interest may retransmit the preamble in accordance with the random access process. According to the conventional process, the UE may adjust its transmission time and transmission power level based on a new measurement and transmit another preamble after the random delay period or wait time (e.g., expiration of T300 timer).

In some RATs, such as Wideband Code Division Multiple Access (W-CDMA), or LTE, the UE typically waits for a shorter time interval in order to have time to transmit a second preamble if the fallback first preamble fails. Additionally, for other RATs, such as TD-SCDMA, the UE may have a wait time of four periods plus a random delay period, to subsequently transmit a second preamble in case of the failure of the first preamble. The wait time increases latency of CSFB by increasing the time spent during the random access process for CSFB.

Further, some RATs, such as W-CDMA or LTE, include 64 preambles per cell. In comparison, other RATs, such as TD-SCDMA, specify 8 preambles to be selected by UEs for the random access process. As a result of the reduced number of available preambles, an increased probability of random access channel collision (i.e., two or more UEs randomly selecting the same preamble) is associated with TD-SCDMA networks relative to W-CDMA or LTE networks. The increased probability of collision associated with some networks further increases latency of CSFB.

Aspects of the present disclosure are directed to reducing collisions and the time spent in the random access process for circuit-switched fallback from one RAT to another RAT. According to an aspect of the present disclosure, a specified UE is redirected to a first RAT (e.g., TD-SCDMA) due to circuit switch fallback via a connection release from the second RAT (e.g., LTE radio resource control (RRC) connection release). The UE may be redirected based on redirection information that includes a dedicated preamble and valid time period (e.g., 1-2 seconds) for the specified UE to perform random access procedure in the first RAT. The redirection information may be transmitted by the second RAT (e.g., LTE eNodeB) to the specified UE.

In some aspects, the second RAT may also transmit an indicator to inform the UE when the dedicated preamble assigned or allocated to the UE is already transmitted to other UEs or identified to be transmitted to the other UEs. The indicator may be a flag indicating whether the dedicated preamble is transmitted to other UEs or identified to be transmitted to the other UEs. For example, the flag is ‘zero’ when the dedicated preamble is not already transmitted or not identified to be transmitted to the other UEs. Similarly, the flag is ‘one’ when the dedicated preamble is already transmitted to the other UEs and not assigned for the other UEs or the dedicated preamble is identified to be transmitted to the other UEs.

In some aspects of the disclosure, random access responses for the dedicated preambles are transmitted earlier in a random access response monitor window when dedicated and non-dedicated preambles are detected. In some instances, transmission of the random access responses for at least some of the detected non-dedicated (common) preambles are skipped or discarded. The transmission is skipped or discarded when all of the random access responses for the detected dedicated and non-dedicated preambles cannot be transmitted in the random access response window.

During the valid time period, the UE uses the dedicated preamble instead of randomly selecting a common preamble (or non-dedicated preamble) to perform the random access procedure. During the valid time period, only the specified UE is guaranteed use of the dedicated preamble to perform the random access procedure. In some aspects of the present disclosure, the first RAT (e.g., TD-SCDMA) transmits system information to other idle mode UEs to prevent them from using the dedicated preamble during a time period assigned to the specified UE.

The dedicated preamble, however, is only valid during the valid time period. When the valid time period expires and the UE fails to receive a random access response (e.g., ACK) from the network, the UE reverts back to randomly selecting a common preamble from one of the N synchronization uplink (SYNC-UL) sequences. In this case, the UE performs the random access procedure with the non-dedicated preamble when no response is received to the dedicated preamble and the time period expires. In some aspects of the disclosure, the redirection information may include more than one dedicated preamble (e.g., 2) for the same valid time period. For example, the UE may perform the random access process with a second dedicated preamble when no response is received to a first dedicated preamble, and when the valid time period has not expired. Allocating the dedicated preamble for the specified UE effectively prevents the occurrence of preamble collision and reduces the latency of CSFB from the second RAT to the first RAT.

In some aspects of the disclosure, the time period may be adjusted when the dedicated preamble assigned to the UE is already transmitted to other UEs or is identified to be transmitted to the other UEs. The time period, in this case, may be adjusted based on a signal quality/strength of a target cell. For example, the time period is increased when the signal strength/quality of the target cell in increased. Further, the time period may be adjusted based on a transmission power for the dedicated preamble. For example, the time period may be reduced (i.e., the time the UE uses one or more dedicated preambles is reduced) when the preamble transmission power is increased. In some instances, the UE aborts transmission of other preambles (e.g., other dedicated preambles) before the UE receives a random access response for the dedicated preamble and before the time period expires when the transmission power is further increased to a threshold or predefined value, for example.

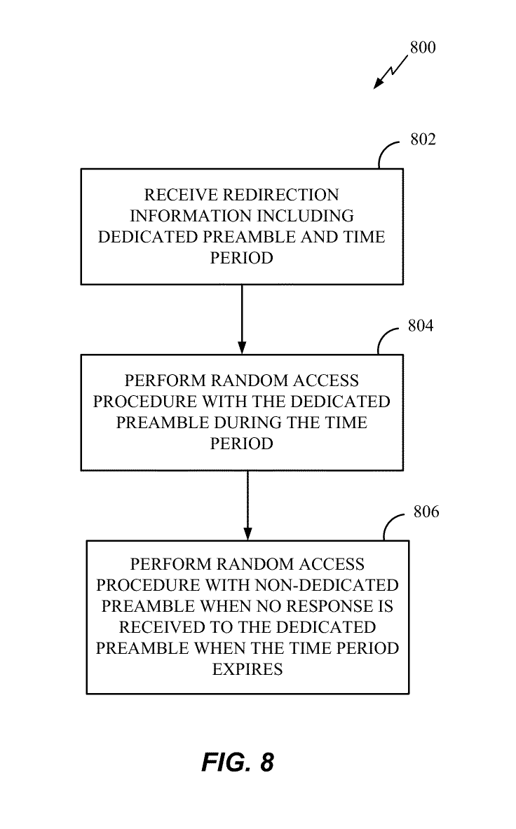

FIG. 8 is a block diagram illustrating a wireless communication method 800 for a dedicated preamble according to aspects of the present disclosure. A UE receives redirection information including one or more dedicated preambles and a time period, as shown in block 802. The UE performs a random access procedure with one of the dedicated preambles during the time period, as shown in block 804. The UE performs the random access procedure with a non-dedicated preamble when no response is received for the dedicated preamble when the time period expires, as shown in block 806.

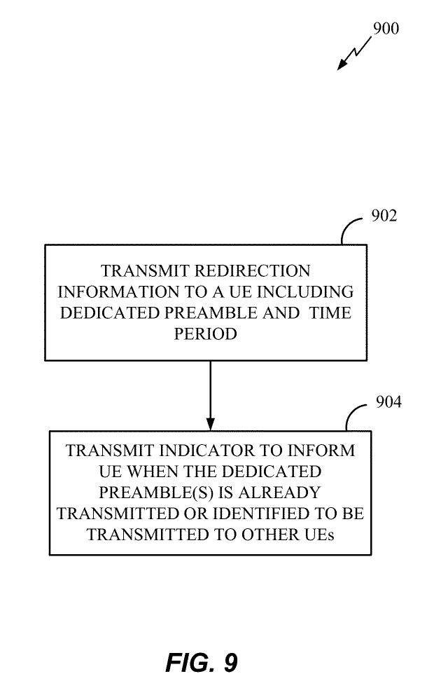

FIG. 9 is a block diagram illustrating a wireless communication method 900 for a dedicated preamble according to aspects of the present disclosure. A base station (e.g., NodeB or eNodeB) transmits redirection information including one or more dedicated preambles and a time period, as shown in block 902. The base station transmits an indicator to inform a user equipment (UE) when the dedicated preamble is already transmitted or when the dedicated preamble is identified to be transmitted to other UEs, as shown in block 904.

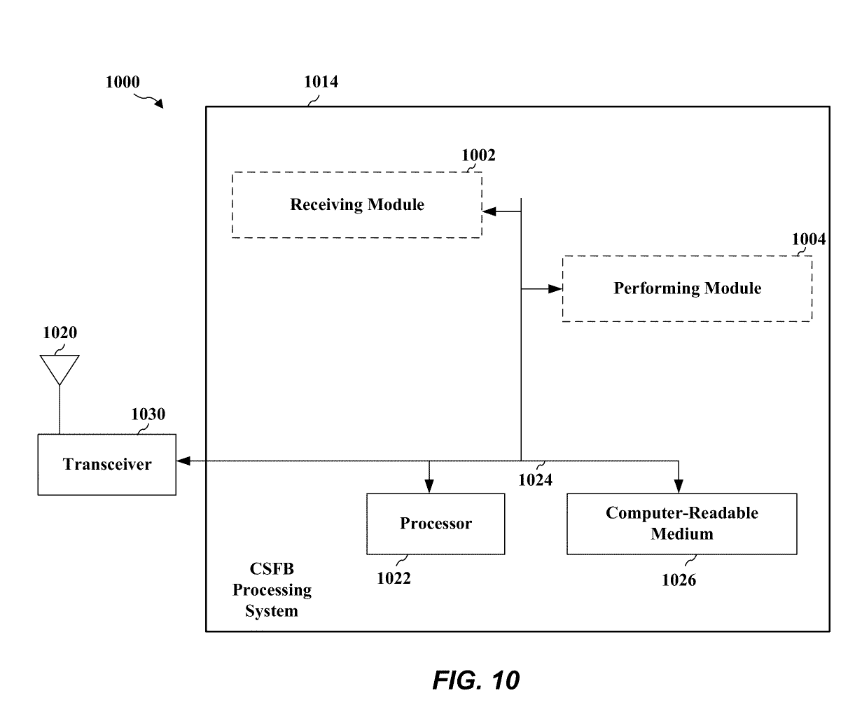

FIG. 10 is a diagram illustrating an example of a hardware implementation for an apparatus 1000 employing a circuit switched fall back (CSFB) processing system 1014. The CSFB processing system 1014 may be implemented with a bus architecture, represented generally by the bus 1024. The bus 1024 may include any number of interconnecting buses and bridges depending on the specific application of the CSFB processing system 1014 and the overall design constraints. The bus 1024 links together various circuits including one or more processors and/or hardware modules, represented by the processor 1022, the receiving module 1002, the performing module 1004, and the computer-readable medium 1026. The bus 1024 may also link various other circuits such as timing sources, peripherals, voltage regulators, and power management circuits, which are well known in the art, and therefore, will not be described any further.

The apparatus includes a CSFB processing system 1014 coupled to a transceiver 1030. The transceiver 1030 is coupled to one or more antennas 1020. The transceiver 1030 enables communicating with various other apparatus over a transmission medium. The CSFB processing system 1014 includes a processor 1022 coupled to a computer-readable medium 1026. The processor 1022 is responsible for general processing, including the execution of software stored on the computer-readable medium 1026. The software, when executed by the processor 1022, causes the CSFB processing system 1014 to perform the various functions described for any particular apparatus. The computer-readable medium 1026 may also be used for storing data that is manipulated by the processor 1022 when executing software.

The CSFB processing system 1014 includes a receiving module 1002 for receiving redirection information including one or more dedicated preambles and a time period. The CSFB processing system 1014 also includes a performing module 1004 for performing a random access procedure with one of the dedicated preambles during the time period. The performing module 1004 may also perform the random access procedure with a non-dedicated preamble when no response is received for the dedicated preamble when the time period expires. The modules may be software modules running in the processor 1022, resident/stored in the computer-readable medium 1026, one or more hardware modules coupled to the processor 1022, or some combination thereof. The CSFB processing system 1014 may be a component of the UE 350 and may include the memory 392, and/or the controller/processor 390.

In one configuration, an apparatus such as an UE 350 is configured for wireless communication including means for receiving. In one aspect, the above means may be the antenna 352, the receiver 354, the transceiver 1030, the receive processor 370, channel processor 394, the controller/processor 390, the memory 392, the CSFB module 391, the receiving module 1002, the processor 1022, and/or the CSFB processing system 1014 configured to perform the functions recited by the aforementioned means. In another aspect, the aforementioned means may be any module or any apparatus configured to perform the functions recited by the aforementioned means.

In one configuration, the apparatus configured for wireless communication also includes means for performing. In one aspect, the above means may be the channel processor 394, the receive processor 370, the transmit processor 380, the controller/processor 390, the memory 392, the CSFB module 391, the performing module 1004, the processor 1022, and/or the CSFB processing system 1014 configured to perform the functions recited by the aforementioned means. In another aspect, the aforementioned means may be a module or any apparatus configured to perform the functions recited by the aforementioned means.

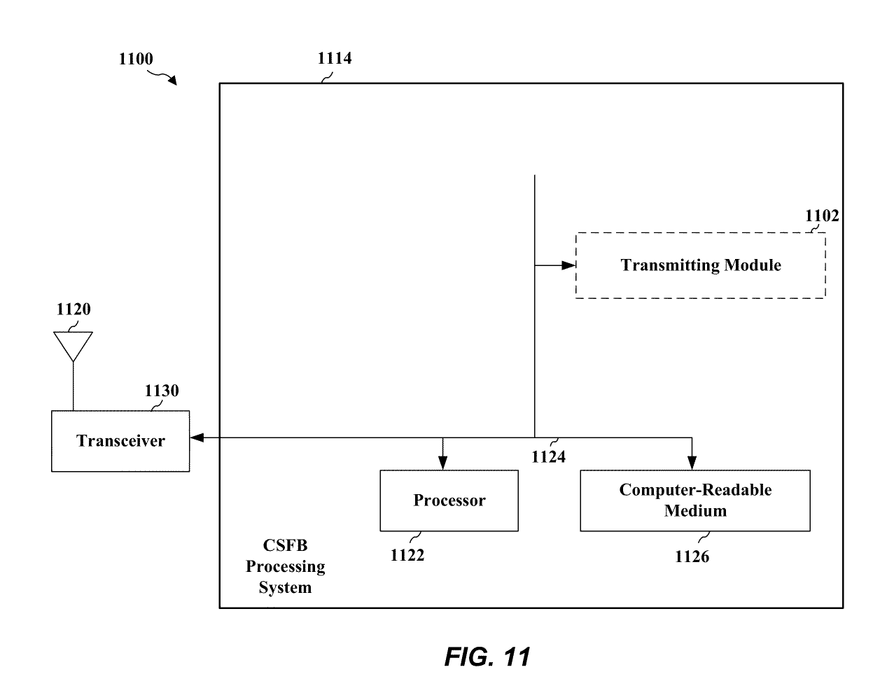

FIG. 11 is a diagram illustrating an example of a hardware implementation for an apparatus 1100 employing a CSFB processing system 1114. The CSFB processing system 1114 may be implemented with a bus architecture, represented generally by the bus 1124. The bus 1124 may include any number of interconnecting buses and bridges depending on the specific application of the CSFB processing system 1114 and the overall design constraints. The bus 1124 links together various circuits including one or more processors and/or hardware modules, represented by the processor 1122, the transmitting module 1102, and the computer-readable medium 1126. The bus 1124 may also link various other circuits such as timing sources, peripherals, voltage regulators, and power management circuits, which are well known in the art, and therefore, will not be described any further.

The apparatus includes a CSFB processing system 1114 coupled to a transceiver 1130. The transceiver 1130 is coupled to one or more antennas 1120. The transceiver 1130 enables communicating with various other apparatus over a transmission medium. The CSFB processing system 1114 includes a processor 1122 coupled to a computer-readable medium 1126. The processor 1122 is responsible for general processing, including the execution of software stored on the computer-readable medium 1126. The software, when executed by the processor 1122, causes the CSFB processing system 1114 to perform the various functions described for any particular apparatus. The computer-readable medium 1126 may also be used for storing data that is manipulated by the processor 1122 when executing software.

The CSFB processing system 1114 includes a transmitting module 1102 for transmitting redirection information including at least one dedicated preamble and a time period. The transmitting module 1102 may also transmit an indicator to inform a user equipment (UE) when the at least one dedicated preamble are already transmitted or are identified to be transmitted to other UEs. The modules may be software modules running in the processor 1122, resident/stored in the computer-readable medium 1126, one or more hardware modules coupled to the processor 1122, or some combination thereof The CSFB processing system 1114 may be a component of the node B 310 and may include the memory 342, and/or the controller/processor 340.

In one configuration, an apparatus such as a node B 310 is configured for wireless communication including means for transmitting. In one aspect, the above means may be the antenna 334, the transmitter 332, the transmit processor 320, the controller/processor 340, the memory 342, the CSFB module 393, the scheduler/processor 346, the transmitting module 1102, the processor 1122, and/or the CSFB processing system 1114 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA, GSM and LTE systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Global System for Mobile Communications (GSM), Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication during circuit switch fall back (CSFB), comprising:
receiving redirection information including at least one dedicated preamble and a time period;
performing a random access procedure with one of the at least one dedicated preamble during the time period; and
performing the random access procedure with a non-dedicated preamble when no response is received to the one of the at least one dedicated preamble when the time period expires.

2. The method of claim 1, further comprising performing the random access procedure with another of the at least one dedicated preamble when no response is received to the one of the at least one dedicated preamble, and when the time period has not expired.

3. The method of claim 1, further comprising adjusting the time period when the at least one dedicated preamble is already transmitted or is identified to be transmitted to other user equipments (UEs).

4. The method of claim 3, further comprising adjusting the time period for the at least one dedicated preamble based at least in part on a signal quality and/or a signal strength of a target cell.

5. The method of claim 3, further comprising adjusting the time period for the at least one dedicated preamble based at least in part on a transmission power of the at least one dedicated preamble.

6. The method of claim 3, further comprising aborting transmission of other preambles before a user equipment (UE) receives a random access response and before the time period expires when an increased transmission power is used to transmit the at least one dedicated preamble.

7. A method of wireless communication during circuit switch fall back (CSFB), comprising:
transmitting redirection information including at least one dedicated preamble and a time period; and
transmitting an indicator to inform a user equipment (UE) when the at least one dedicated preamble is already transmitted or identified to be transmitted to other UEs.

8. The method of claim 7, in which the indicator comprises a flag.

9. The method of claim 8, in which the flag is set to a value of zero when the at least one dedicated preamble is not already transmitted or identified to be transmitted to other UEs.

10. The method of claim 8, in which the flag is set to a value of one when at least one dedicated preamble is already transmitted to the other UEs and not detected for the other UEs or the at least one dedicated preamble is identified to be transmitted to the other UEs.

11. The method of claim 7, further comprising transmitting a dedicated random access response within an earlier random access response monitor window when both common and dedicated preambles are detected.

12. The method of claim 7, further comprising discarding a random access response for at least one detected common preamble when both common and dedicated preambles are detected and not all of random access response can be sent in the random access response window.

13. An apparatus for wireless communication during circuit switch fall back (CSFB), comprising:
a memory; and
at least one processor coupled to the memory and configured:
to receive redirection information including at least one dedicated preamble and a time period;
to perform a random access procedure with one of the at least one dedicated preamble during the time period; and
to perform the random access procedure with a non-dedicated preamble when no response is received to the one of the at least one dedicated preamble when the time period expires.

14. The apparatus of claim 13, in which the at least one processor is further configured to perform the random access procedure with another of the at least one dedicated preamble when no response is received to the one of the at least one dedicated preamble, and when the time period has not expired.

15. The apparatus of claim 13, in which the at least one processor is further configured to adjust the time period when the at least one dedicated preamble is already transmitted or is identified to be transmitted to other user equipments (UEs).

16. The apparatus of claim 15, in which the at least one processor is further configured to adjust time period for the at least one dedicated preamble based at least in part on a signal quality and/or a signal strength of a target cell.

17. The apparatus of claim 15, in which the at least one processor is further configured to adjust the time period for the at least one dedicated preamble based at least in part on a transmission power of the at least one dedicated preamble.

18. The apparatus of claim 15, in which the at least one processor is further configured to abort transmission of other preambles before a user equipment (UE) receives a random access response and before the time period expires when an increased transmission power is used to transmit the at least one dedicated preamble.

19. An apparatus for wireless communication during circuit switch fall back (CSFB), comprising:
a memory; and
at least one processor coupled to the memory and configured:
to transmit redirection information including at least one dedicated preamble and a time period; and
to transmit an indicator to inform a user equipment (UE) when the at least one dedicated preamble is already transmitted or identified to be transmitted to other UEs.

20. The apparatus of claim 19, in which the indicator comprises a flag.

21. The apparatus of claim 20, in which the flag is set to a value of zero when the at least one dedicated preamble is not already transmitted or identified to be transmitted to other UEs.

22. The apparatus of claim 20, in which the flag is set to a value of one when the at least one dedicated preamble is already transmitted to the other UEs and not detected for the other UEs or the at least one dedicated preamble is identified to be transmitted to the other UEs.

23. The apparatus of claim 19, in which the at least one processor is further configured to transmit a dedicated random access response within an earlier random access response monitor window when both common and dedicated preambles are detected.

24. The apparatus of claim 19, in which the at least one processor is further configured to discard a random access response for at least one detected common preamble when both common and dedicated preambles are detected and not all of random access response can be sent in the random access response window.
